(19) United States
(12) Patent Application Publication
(10) Pub. No.: US 2020/0267451 A1
(43) Pub. Date: Aug. 20, 2020

(54) APPARATUS AND METHOD FOR OBTAINING ENHANCED USER FEEDBACK RATING OF MULTIMEDIA CONTENT

(71) Applicant: THOMSOM Licensing, Issy-les-Moulineaux (FR)

(72) Inventors: Ajith PUDHIYAVEETIL, Sunnyvale, CA (US); Nadia FAWAZ, Santa Clara, CA (US); Hossein ABADI, Palo Alto, CA (US); Arshit GUPTA, Piitsburg, PA (US); Kevin Shual XU, Toledo, OH (US); Yan LI, Warren, MI (US); Yun-Jhong WU, Ann Arbor, MI (US); William TROULEAU, Gex (FR)

(21) Appl. No.: 16/061,411

(22) PCT Filed: Dec. 14, 2015
(86) PCT No.: PCT/US2015/065490

§ 371 Date: Jun. 12, 2018

(51) Int. Cl. H04N 21/475; H04N 21/466

(52) U.S. Cl. CPC H04N 21/4756; H04N 21/4667

(57) ABSTRACT

The present principles generally relate to multimedia processing and viewing, and particularly, to apparatuses and methods for obtaining enhanced user feedback ratings of a multimedia program. In an exemplary embodiment, viewers are provided with different opportunities to provide user feedback including feedback ratings for the multimedia program during various points in the playout of the program. The various points can be based on the content of the program or during different selected time intervals during the playout of the program.

### FIELD OF INVENTION

The present principles generally relate to multimedia content processing and viewing, and particularly, to apparatuses and methods for obtaining enhanced user feedback rating of multimedia content.

### BACKGROUND

Many different multimedia content streaming and downloading services and websites are available to consumers today. For example, services such as Netflix, Amazon, Hulu and M-GO allow a user to watch different multimedia content on different user devices. As is well known in the art, multimedia content has content in more than one component or form, such as, for example, a movie or a television show which has both a video component and an audio component.

Almost all of the current services would allow a user to rate a program. The feedback ratings of the multimedia content provided by the individual users are typically used by the current services to recommend other programs which may be of interest to the same users. In addition, the cumulative ratings for the programs provided by the many users may also be used by a potential user to see if he or she would enjoy a program, or to search for a program based on the user ratings.

### SUMMARY

The present principles recognize that the current feedback rating systems described above do not take into consideration the different program contexts such as the different storylines or plots within the same multimedia program being presented. In addition, the current feedback systems also lack the ability to take into account the finer granularities of a multimedia program either in time or content. That is, for example, a user may develop a different opinion or rating about the program, as the program is being played out and as the program content progresses. In addition, the present principles also recognize that a user may ask for a refund in different times during a play back of the program, and it would be advantageous to request user feedbacks during such times to further improve the user feedback ratings. Furthermore, in order to encourage user feedbacks about the program, appropriate rewards may be provided to the user. Accordingly, enhanced user rating apparatuses and methods are presented.

Therefore, a multimedia apparatus is presented, comprising a display configured to display a multimedia program; a user input device configured to receive a plurality of feedback ratings for the multimedia program; a processor configured to determine at least one content event that occurs within the multimedia program, the content event relating to a selected scene within the multimedia program, wherein the scene is selected based on the content of the multimedia program; determine a weighting of the at least one content event, wherein the weighting has a weighting value; determine a number of content events that occur during a playback of at least a portion of the multimedia program and their respective weighting values; receive at least one feedback rating from at least one user for the at least one content event during the playback of the at least a portion of the multimedia program; and transform the feedback rating into a final feedback rating of the multimedia program based on the weighting value of the at least one content event in relation to total weighting values of all of the content events during the playback of the at least a portion of the multimedia program

In another exemplary embodiment, a method performed by a multimedia apparatus is presented, comprising: causing a multimedia program to be displayed; determining at least one content event that occurs within the multimedia program, the content event relating to a selected scene within the multimedia program, wherein the scene is selected based on the content of the multimedia program; determining a weighting of the at least one content event, wherein the weighting has a weighting value; determining a number of content events that occur during a playback of at least a portion of the multimedia program and their respective weighting values; receiving at least one feedback rating from at least one user for the at least one content event during the playback of the at least a portion of the multimedia program; and transforming the feedback rating into a final feedback rating of the multimedia program based on the weighting value of the at least one content event in relation to total weighting values of all of the content events during the playback of the at least a portion of the multimedia program.

In another exemplary embodiment, a computer program product stored in a non-transitory computer-readable storage medium, comprising computer-executable instructions for: causing a multimedia program to be displayed; determining at least one content event that occurs within the multimedia program, the content event relating to a selected scene within the multimedia program, wherein the scene is selected based on the content of the multimedia program; determining a weighting of the at least one content event, wherein the weighting has a weighting value; determining a number of content events that occur during a playback of at least a portion of the multimedia program and their respective weighting values; receiving at least one feedback rating from at least one user for the at least one content event during the playback of the at least a portion of the multimedia program; and transforming the feedback rating into a final feedback rating of the multimedia program based on the weighting value of the at least one content event in relation to total weighting values of all of the content events during the playback of the at least a portion of the multimedia program.

### DETAILED DESCRIPTION OF THE DRAWINGS

The above-mentioned and other features and advantages of the present principles, and the manner of attaining them, will become more apparent and the present principles will be better understood by reference to the following description of embodiments of the present principles taken in conjunction with the accompanying drawings, wherein:

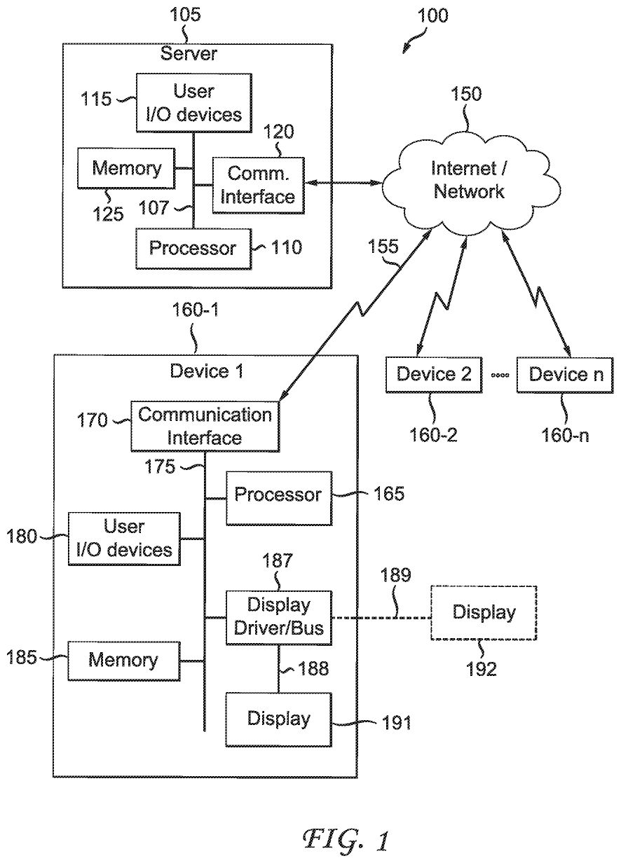

FIG. 1 shows an exemplary system according to an embodiment of the present principles;

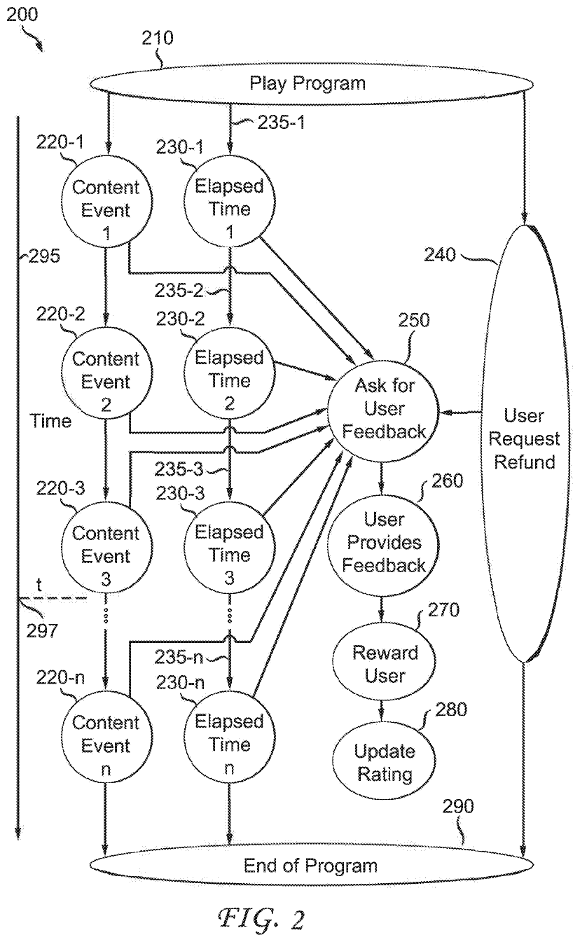

FIG. 2 shows an exemplary process according to an embodiment of the present principles;

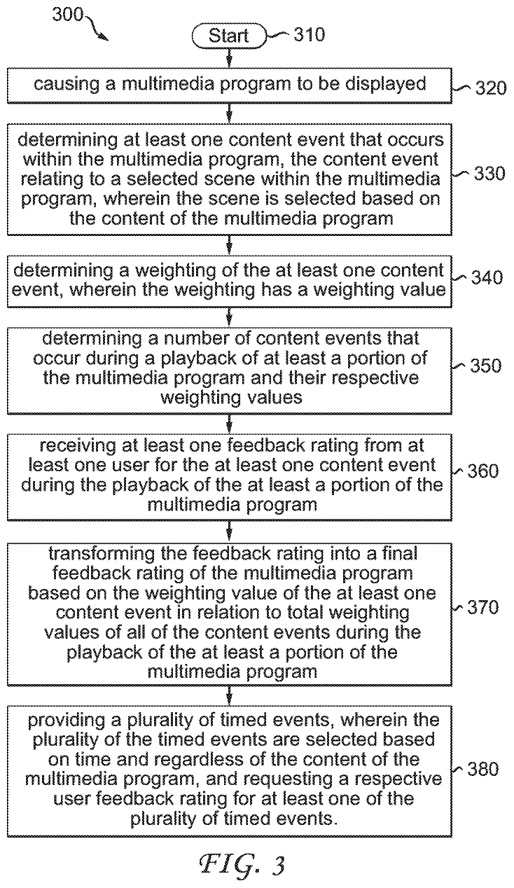

FIG. 3 shows another exemplary process according to an embodiment of the present principles; and

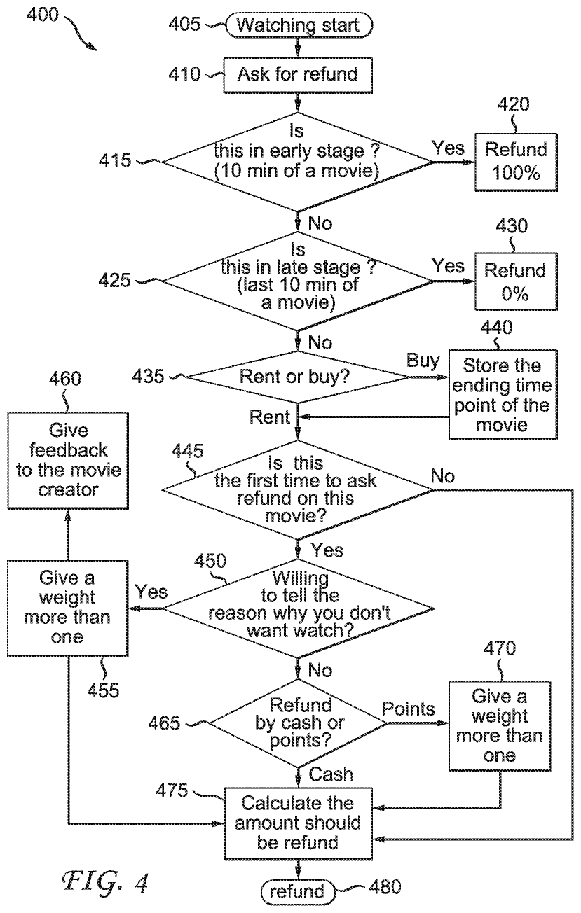

FIG. 4 shows another exemplary process according to an embodiment of the present principles.

The examples set out herein illustrate exemplary embodiments of the present principles. Such examples are not to be construed as limiting the scope of the present principles in any manner.

### DETAILED DESCRIPTION

Accordingly, the present principles generally relate to multimedia processing and viewing, and particularly, to apparatuses and methods for obtaining enhanced user rating of multimedia content. In an exemplary embodiment, viewers are provided with different opportunities to provide user feedback including feedback ratings for the multimedia program during the various points in the playout of the program. The various points can be based on events that occur in the content of the program or during different selected time intervals during the playout of the program. Also, a user may request a refund during the playback of the program. If a refund request is made by the user, a request is made by the system to the user to obtain further user feedback as to why the user is seeking the refund. Different incentives are provided to the user seeking the refund to better obtain the user feedback. Hence, enhanced user rating apparatuses and methods are presented.

The present description illustrates the present principles. It will thus be appreciated that those skilled in the art will be able to devise various arrangements that, although not explicitly described or shown herein, embody the present principles and are included within its scope.

All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment,” “an embodiment,” “an exemplary embodiment” of the present principles, or as well as other variations thereof, means that a particular feature, structure, characteristic, and so forth described in connection with the embodiment is included in at least one embodiment of the present principles. Thus, the appearances of the phrase “in one embodiment,” “in an embodiment,” “in an exemplary embodiment,” or as well any other variations, appearing in various places throughout the specification are not necessarily all referring to the same embodiment.

It is to be appreciated that the use of any of the following “/,” “and/or,” and “at least one of,” for example, in the cases of “A/B,” “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

FIG. 1 shows an exemplary system according to the present principles. For example, a system 100 in FIG. 1 includes a content server 105 which is capable of receiving and processing user requests from one or more of user devices 160-1 to 160-n. The content server 105, in response to the user requests, provides program contents comprising various multimedia programs such as games, movies or TV shows for viewing, streaming or downloading by users using the devices 160-1 to 160-n.

Various exemplary user devices 160-1 to 160-n in FIG. 1 can communicate with the exemplary server 105 over a communication network 150 such as the Internet, a wide area network (WAN), and/or a local area network (LAN). The content server 105 can communicate with user devices 160-1 to 160-n in order to provide to the user devices and/or receive from the user devices relevant information such as metadata, web pages, media contents, etc. The content server 105 can also provide additional processing of information and data when the processing is not available and/or capable of being conducted on the local user devices 160-1 to 160-n. As an example, the content server 105 can be a computer having a processor 110 such as, e.g., an Intel processor, running an appropriate operating system such as, e.g., Windows 2008 R2, Windows Server 2012 R2, Linux operating system, etc.

User devices 160-1 to 160-n shown in FIG. 1 can be one or more of a personal computer (PC), a mobile device (e.g., a laptop, a tablet, a cellphone, etc.), and/or a video receiver and the like. Examples of such devices can be, e.g., a Microsoft Windows 10 computer/tablet, an Android phone/tablet, an Apple IOS phone/tablet, a television receiver, or the like. A detailed block diagram of an exemplary user device according to the present principles is illustrated in block 160-1 of FIG. 1 as Device 1 and will be further described below.

An exemplary user device 160-1 in FIG. 1 comprises a processor 165 for processing various data and for controlling various functions and components of the device 160-1, including video encoding/decoding and other processing capabilities in order to play, display and/or transport a video content. The processor 165 communicates with and controls the various functions and components of the device 160-1 via a control bus 175 as shown in FIG. 1.

Device 160-1 can also comprise a display 191 which is driven by a display driver/bus component 187 under the control of processor 165 via a display bus 188 as shown in FIG. 1. The display 191 can be a touch display. In addition, the type of the display 191 can be, e.g., LCD (Liquid Crystal Display), LED (Light Emitting Diode), OLED (Organic Light Emitting Diode), etc. In addition, an exemplary user device 160-1 according to the present principles can have its display outside of the user device or that an additional or a different external display can be used to display the content provided by the display driver/bus component 187. This is illustrated, e.g., by an external display 192 which is connected to an external display connection 189 of device 160-1 of FIG. 1.

In additional, exemplary device 160-1 in FIG. 1 can also comprise user input/output (I/O) devices 180. The user interface devices 180 of the exemplary device 160-1 can represent e.g., a mouse, touch screen capabilities of a display (e.g., display 191 and/or 192), a touch and/or a physical keyboard for inputting user data. The user interface devices 180 of the exemplary device 160-1 can also comprise a speaker or speakers and/or other indicator devices, for outputting visual and/or audio sound, user data and feedback.

Exemplary device 160-1 also comprises a memory 185 which can represent both a transitory memory such as RAM, and a non-transitory memory such as a ROM, a hard drive and/or a flash memory, for processing and storing different files and information as necessary, including computer program products and software (e.g., as represented by flow chart diagrams of FIG. 2 to FIG. 4 to be discussed below), webpages, user interface information, databases, etc., as needed. In addition, Device 160-1 also comprises a communication interface 170 for connecting and communicating to/from server 105 and/or other devices, via, e.g., the network 150 using the link 155 representing, e.g., a connection through a cable network, a FIOS network, a Wi-Fi network and/or a cellphone network (e.g., 3G, 4G, LTE), etc.

According to the present principles, user devices 160-1 to 160-n in FIG. 1 can access different media programs, web pages, services or databases provided by the content server 105 using, e.g., HTTP protocol. A well-known web server software application which can be run by the content server 105 to provide web pages is Apache HTTP Server software available from http://www.apache.org. Likewise, examples of well-known media server software applications include Adobe Media Server and Apple HTTP Live Streaming (HLS) Server, for example. Using media server software as mentioned above and/or other open or proprietary server software, the content server 105 can provide multimedia content services similar to, e.g., Amazon.com, Netflix, or M-GO. The content server 105 can use a streaming protocol such as e.g., Apple HTTP Live Streaming (HLS) protocol, Adobe Real-Time Messaging Protocol (RTMP), Microsoft Silverlight Smooth Streaming Transport Protocol, etc., to transmit various programs comprising various multimedia assets such as, e.g., movies, TV shows, software, games, electronic books, electronic magazines, etc., to an end-user device 160-1 for purchase and/or viewing via streaming, downloading, receiving or the like.

Turning to further detail of the web and content server 105 of FIG. 1, the server 105 can comprise a processor 110 which controls the various functions and components of the server 105 via a control bus 107 as shown in FIG. 1. In addition, a server administrator can interact with and configure the server 105 to run different applications using different user input/output (I/O) devices 115 (e.g., a keyboard and/or a display) as well known in the art. The server 105 also comprises a memory 125 which can represent both a transitory memory such as RAM, and a non-transitory memory such as a ROM, a hard drive and/or a flash memory, for processing and storing different files and information as necessary, including computer program products and software (e.g., as represented by flow chart diagrams of FIG. 2 to FIG. 4 to be discussed below), webpages, user interface information, user profiles, metadata, electronic program listing information, databases, search engine software, etc., as needed. A search engine can be stored in the non-transitory memory 125 of sever 105 as necessary, so that multimedia recommendations can be made, e.g., in response to a user's profile of disinterest and/or interest in certain multimedia assets, and/or criteria that a user specifies using textual input (e.g., queries using “sports,” “adventure,” “Tom Cruise,” etc.), or based on ratings of the available multimedia programs.

In addition, the server 105 is connected to the network 150 through a communication interface 120 for communicating with other servers or web sites (not shown) and one or more user devices 160-1 to 160-n, as shown in FIG. 1. The communication interface 120 can also represent television signal modulator and RF transmitter in the case when the content server 105 represents a television station, cable or satellite television provider. In addition, one skilled in the art would readily appreciate that other well-known server components, such as, e.g., power supplies, cooling fans, etc., can also be needed, but are not shown in FIG. 1 to simplify the drawing.

FIG. 2 to FIG. 4 represent flow chart diagrams of exemplary processes 200, 300 and 400, respectively, according to the present principles. These exemplary processes can be implemented as computer program products comprising computer executable instructions which can be executed by a processor (e.g., the processor 110 of the server 105 and/or the processor 165 of the device 160-1 of FIG. 1). The computer program products having the computer-executable instructions can be stored in a non-transitory computer-readable storage medium as represented by e.g., the memory 125 of the server 105 or the memory 185 of the device 160-1 of FIG. 1, as described above. One skilled in the art can readily recognize that the exemplary processes can also be implemented using a combination of hardware and software (e.g., a firmware implementation), and/or executed using programmable logic arrays (PLA) or application-specific integrated circuit (ASIC), etc., as already mentioned above.

According to the present principles, a state transition diagram representing an exemplary process 200 is shown in FIG. 2. In state 210 of FIG. 2, a program such as a multimedia program representing, e.g., a game, a movie or a TV show is being streamed from e.g., a content server 105 and being played out on a user device 160-1 of FIG. 1. Also in FIG. 2, the left hand side of the state transition diagram 200 shows a timeline 295 representing the elapsed time of the program content being played out.

FIG. 2 also shows a plurality of states 220-1 to 220-n representing respectively a plurality of different content events 220-1 to 220-n which have been defined for the program being watched. In one exemplary embodiment, the content events 220-1 to 220-n relate respectively to selected scenes within the multimedia program, and the scenes are selected based on the content of the multimedia program. For example, the selected scenes can be related to an important and/or dramatic plot of the storyline of a movie or a TV such as, e.g., when a baby is born or when there is a marriage or a cliff hanger. In an exemplary embodiment, these content events can be defined and selected by a creator of or someone associated with the program such as, e.g., a director or writer of the program in order to obtain better user feedback for certain important scenes as defined by the director and/or writer. In another exemplary embodiment, the events are automatically selected by monitoring the content for influences on the audience such as when dramatic sound events occur and/or when audience members show an increase or decrease in emotions, etc. Physiological indicators can be obtained through sensors placed on content watchers and the like to aid in determining when significant events occur.

In addition, a plurality of elapsed time events 230-1 to 230-n are also shown in the state transition diagram of FIG. 2. In one exemplary embodiment, the plurality of the time events 230-1 to 230 are selected based on the elapsed time of the multimedia program being played, without regard to the actual content of the multimedia program. In another exemplary embodiment, the respective time intervals 235-1 to 235-n between the plurality of the elapsed time events 230-1 to 230-n gradually increase as the multimedia program is being played out as shown in FIG. 2. In another embodiment, the respective time intervals 235-1 to 235-n can be substantially the same or gradually decreased (not shown).

Also as shown in state 250 of FIG. 2, an exemplary device 160-1 of FIG. 1 can request user feedback from a user of the device during one or more of the content event states 220-1 to 220-n, and/or time event states 230-1 to 230-n. In accordance with the present principles, a user can also request a refund any time during the play back of the program, as shown in state 240. If a refund request is made by the user in state 240, then a request can be made by the system to the user to obtain further user feedback as to why the user is seeking the refund in state 250.

In response to the request for user feedback in state 250, a user can provide user feedback as shown in state 260 of FIG. 2. In state 270 of FIG. 2, a user is provided with rewards or incentives based on the previous user behaviors in the previous states. In state 280, a final feedback rating is updated and provided to the content service to be used by the service and/or the users of the service as described before and to be further described below. These aspects of the present principles are also described further below in connection with FIG. 3 and FIG. 4.

FIG. 3 shows another exemplary process 300 according to the present principles. The exemplary process 300 starts at step 310. At step 320, an exemplary multimedia device 160-1 causes a multimedia program to be played and displayed on a display 191 and/or 192 in FIG. 1, as described previously. At step 330, device 160-1 determines at least one content event (e.g., one of the content events 220-1 to 220-n shown in FIG. 2) that occurs within the multimedia program. According to the present principles, the content event relates to a selected scene within the multimedia program, and the scene is selected based on events in the content of the multimedia program. Again, the selected scenes can be related to, e.g., an important and/or dramatic plot of the storyline of a movie or a TV such as, e.g., when a baby is born, when a breakup between two main characters happens, or when there is a murder, an explosion or a cliff hanger, etc. In an exemplary embodiment, these content events can be defined and selected by a creator of the program such as a director or writer of the program, in order for them to gain additional user feedback in certain important scenes as defined by them so that better content can be created in the future. In other exemplary embodiments, as noted above, the content events can be automatically determined.

At step 340 of FIG. 3, a weighting of the at least one content event is determined, and the weighting has a weighting value. That is, in an exemplary embodiment according to the present principles, each content event of the plurality of content events 220-1 to 220-n shown in FIG. 2 can be weighted. In one exemplary embodiment, each content event can be weighted based on, e.g., how important or impactful a creator such as a director or a writer feels about a particular scene verses other scenes in the movies. For example, if a director or a writer feels that the particular content event is twice as powerful or impactful in regards to the storyline as the other content events in the program, a weighting value or 2 can be assigned to the weighting. One skilled in art can readily recognize that other numerical weighting values can be employed to provide a relative weighting of one content event versus the other content events. In another non-limiting exemplary embodiment according to the present principles, the user of the device can be asked to provide the weighting of the respective content event as part of the user input of the feedback ratings instead of being predetermined by the content service as described above. This allows the feedback to indicate points in the storyline that the user felt were significant events and/or how significant an event was in relationship to the storyline.

At step 350 of FIG. 3, the exemplary device 160-1 of FIG. 1 determines a number of content events that occur during a playback of at least a portion of the multimedia program and their respective weighting values. For example, as shown in FIG. 2, at time t 297 on the timeline 295, the device 160-n of FIG. 1 will determine that 3 content events 220-1 to 220-3 have been presented to the user during the playback at time t 297. In addition, each of their respective weighting values will also be determined. Again, these weighting values can be preassigned, automatically determined and/or to be obtained from a user as part of the user feedback input as described in connection with step 340 above.

At step 360 of FIG. 3, at least one feedback rating is received from at least one user for the at least one content event during the playback of the at least a portion of the multimedia program within time t 297. Again, this is also illustrated in state 260 of the state transition diagram of FIG. 2, as described previously.

At step 370 of FIG. 3, a final feedback rating for the multimedia program being watched is calculated by transforming the feedback rating provided by the user at step 360 into a final feedback rating of the multimedia program. This final feedback rating for the multimedia program is based on the weighting value of the at least one content event in relation to total weighting values of all of the content events during the playback of the at least a portion of the multimedia program. That is, for example, if the user has provided a feedback rating of 4 stars for only the content event 3 220-3 of FIG. 2, based on the scale of 1 to 5 stars (with 5 stars being the highest rated), and the content event 3 220-3 of FIG. 2 is weighted as twice as important as both content event 1 220-1 and 220-2 of FIG. 2, then this user rating of the content event 3 220-3 will be weighted or counted twice compared with a user feedback rating associated with the content events of 220-2 and 220-3 to derive the final rating of the multimedia program. That is, all of the ratings from different users and different content events of the program are aggregated, weighted and averaged to derive the overall final rating for the multimedia program. In the state transition diagram of FIG. 2, this calculation and updating of the final feedback rating for the multimedia program is illustrated in state 280 of the state transition diagram 200.

At step 380 of FIG. 3, a plurality of elapsed time events, such as elapsed time events 230-1 to 230-n shown in FIG. 2 are provided by e.g., device 160-1 of FIG. 1. The plurality of the time events is selected based on elapsed time of the program and is not related to the content of the program. In a non-limiting example, a user is requested to provide a user feedback rating for at least one of the plurality of time events. This is also illustrated in state 250 of the state transition diagram 200 shown in FIG. 2.

FIG. 4 shows another exemplary process 400 in accordance with an embodiment of the present principles. In particular, FIG. 4 further illustrates processing of a user refund request and the related user feedback and incentive aspects as shown in states 240 to 280 of the state transition diagram 200 of FIG. 2.

At step 405 of FIG. 4, a multimedia program such as, e.g., a movie is being watched via an exemplary user device 160-1 of FIG. 1. At step 410, a user can request a refund for the program during the playback of the program. At step 415, a determination is first made to check to see if the refund request is made during an early stage of elapsed time of the program content (e.g., if the user request is made within the first 10 minutes of the movie). In one exemplary embodiment, at step 420, if the determination is positive at step 410, then 100% of the purchase price of the movie is refunded to the viewer. However, in other embodiments, the amount of time lapsed is insignificant compared to how many significant events have been watched by a viewer. If a movie plot and result is fully disclosed within the first 10 minutes, the user would only receive a minor refund. In another exemplary embodiment, if on the other hand, the refund request is made during a late stage of the movie (e.g., during the last 10 minutes), then no refund can be made to the viewer as shown at step 430. In yet another embodiment, the multimedia program storyline can be very vague and the plot revealed in only the last two minutes of the movie. In this case, if the user requests a refund before this significant event, they can be refunded a significant portion.

In accordance with the present principles, at step 435, the process 400 then determines whether the program is being rented (e.g., for viewing by a user only for a limited time period) or purchased (e.g., the user is able to view the program for an infinite amount of time and/or is able to download and store the program locally in his or her possession and use at any time). At step 440, if the user has purchased the program as determined by step 435, then the ending time of the movie is stored and recorded.

At step 445, if a user refund request is made during a period which is not in the early stage or at the late stage as described respectively at steps 415 and 425 previously, then a determination is made to check to see if this is the first time the user has asked for a refund on this program. At step 450, if the outcome of the determination at step 445 is yes, then the user is asked to see if he or she is willing to provide user feedback such as, e.g., reasons the user is requesting the refund, or to provide a feedback rating for the program. At step 455, if the user provides the feedback requested at step 450, then the user will be rewarded or incentivized so that the amount refunded will be more than a normal amount (i.e., giving a weight of more than one). In addition, the user provided feedback and/or rating can be conveyed to a creator of the movie, such as a director or writer by the service provider at step 460.

In another non-limiting exemplary embodiment according to the present principles, a determination is made at step 465 to check to see if the user has chosen the refund to be in cash or in points which, e.g., can be used to redeem for more media purchases and/or rentals from the content provider. At step 470, if the user has chosen points as the refund mechanism then the amount refunded will also be more than normal cash amount (i.e., giving a weight more than one). At step 475, the refund amount in cash or in points is calculated based on the previous steps described above. At step 480, the amount to be refunded is credited to the viewer's account.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed can be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiment.

1. A multimedia apparatus, comprising:
a display configured to display a multimedia program;
a user input device configured to receive a plurality of feedback ratings for the multimedia program; and
a processor configured to:
determine at least one content event that occurs within the multimedia program, the content event relating to a scene within the multimedia program, wherein the scene is selected based on the content of the multimedia program;
determine a weighting of the at least one content event, wherein the weighting has a weighting value;
determine a number of content events that occur during a playback of at least a portion of the multimedia program and their respective weighting values;
receive at least one feedback rating from at least one user for the at least one content event during the playback of the at least a portion of the multimedia program; and
transform the feedback rating into a final feedback rating of the multimedia program based on the weighting value of the at least one content event in relation to total weighting values of the content events during the playback of the at least a portion of the multimedia program.

2. The multimedia apparatus of claim 1, wherein the processor is further configured to provide a plurality of elapsed time events, wherein the plurality of the elapsed time events is selected based on playout elapsed time and regardless of the content of the multimedia program.

3. The multimedia apparatus of claim 2, wherein the processor is further configured to request a respective user feedback rating for at least one of the plurality of elapsed time events.

4. The multimedia apparatus of claim 1, wherein the processor is further configured to permit a user initiated request for a refund.

5. The multimedia apparatus of claim 4, wherein the processor is further configured to determine the requested refund based on whether the user has provided another feedback rating.

6. The multimedia apparatus of claim 4, wherein the processor is further configured to determine the requested refund based on whether the user has requested a cash refund.

7. The multimedia apparatus of claim 4, wherein the processor is further configured to determine the requested refund based on a time of the user initiated request for the refund.

8. The multimedia apparatus of claim 1, wherein the weighting of the at least one content event is assigned by a person associated with the multimedia program.

9. The multimedia apparatus of claim 8, wherein the person is a director.

10. The multimedia apparatus of claim 1, wherein the weighting of the at least one content event is assigned by the at least one user.

11. A method performed by a multimedia apparatus, comprising:
determining at least one content event that occurs within a multimedia program, the content event relating to a scene within the multimedia program, wherein the scene is selected based on the content of the multimedia program;
determining a weighting of the at least one content event, wherein the weighting has a weighting value;
determining a number of content events that occur during a playback of at least a portion of the multimedia program and their respective weighting values;
receiving at least one feedback rating from at least one user for the at least one content event during the playback of the at least a portion of the multimedia program; and
transforming the feedback rating into a final feedback rating of the multimedia program based on the weighting value of the at least one content event in relation to total weighting values of all of the content events during the playback of the at least a portion of the multimedia program.

12. The method of claim 11, further comprising providing a plurality of elapsed time events, wherein the plurality of the elapsed time events is selected based on playout elapsed time.

13. The method of claim 12, further comprising requesting a respective user feedback rating for at least one of the plurality of elapsed time events.

14. The method of claim 11, further comprising permitting a user initiated request for a refund.

15. The method of claim 14, further comprising determining the requested refund based on whether the user has provided another feedback rating.

16. The method of claim 14, further comprising determining the requested refund based on a time of the user initiated request for the refund.

17. The method of claim 11, wherein the weighting of the at least one content event is assigned by a person associated with the multimedia program.

18. The method of claim 17, wherein the person is a director.

19. The method of claim 11, wherein the weighting of the at least one content event is assigned by the at least one user.

20. A computer program product stored in a non-transitory computer-readable storage medium, comprising computer-executable instructions for:
determining at least one content event that occurs within a multimedia program, the content event relating to a selected scene within the multimedia program, wherein the scene is selected based on the content of the multimedia program;
determining a weighting of the at least one content event, wherein the weighting has a weighting value;
determining a number of content events that occur during a playback of at least a portion of the multimedia program and their respective weighting values;
receiving at least one feedback rating from at least one user for the at least one content event during the playback of the at least a portion of the multimedia program; and
transforming the feedback rating into a final feedback rating of the multimedia program based on the weighting value of the at least one content event in relation to total weighting values of all of the content events during the playback of the at least a portion of the multimedia program.
